(19) United States
(12) Patent Application Publication
(10) Pub. No.: US 2024/0417028 A1
(43) Pub. Date: Dec. 19, 2024

(54) HYDRAULIC BRAKE ARRANGEMENT FOR AN AT LEAST PARTIALLY MUSCLE-POWERED BICYCLE

(71) Applicant: TRICKSTUFF GMBH, Pfaffenweiler (DE)

(72) Inventors: Christoph SCHEDEL, Freiburg (DE); Simon REIBERG, Freiburg (DE); Lukas SPEICHINGER, Karlsruhe (DE)

(21) Appl. No.: 18/743,918

(22) Filed: Jun. 14, 2024

(30) Foreign Application Priority Data
Jun. 15, 2023 (DE) 10 2023 115 643.8

(51) Int. Cl. B62L 3/02

(52) U.S. Cl. CPC B62L 3/023

(57) ABSTRACT

A bicycle hydraulic brake arrangement with a brake lever resting with a pressure section on a pressure area of a cam body. The brake lever and the cam body are jointly pivotable around the principal pivot axis. The brake lever is pivotable around the setting pivot axis relative to the cam body. A lever width adjusting system is pre-settable re the brake lever pivoting distance around the setting pivot axis, when it rests on the cam body pressure area. The lever width adjusting system includes a barrel nut non-rotatably supported and linearly displaceable in the lever, and a spindle unit rotatably supported in the brake lever and fixed in the axial direction. The barrel nut and the spindle unit are in engagement with one another, so that the barrel nut is linearly displaceable by rotating the spindle unit. The barrel nut provides the pressure section on its barrel bottom.

### BACKGROUND

The present invention relates to a hydraulic brake arrangement for an at least partially muscle-powered bicycle and comprises at least one master unit, which is provided for fluid connection with a slave unit. The master unit comprises a brake lever and a cylinder housing, and a piston unit displaceably accommodated in the cylinder housing.

The system for setting the brake lever width provides the significant feature of easy and safe operation of hydraulic bicycle brakes. The distance respectively pivoting angle of the brake lever relative to the handlebar has considerable influence on whether the brake lever is readily within reach and can be pulled with the required operating force, during riding.

However, setting the lever width may in some cases be very inconvenient or complicated and e.g. always requires tools. This is why setting the optimal lever width tends to be neglected prior to setting out for a ride. Moreover, some systems show the drawback that they simultaneously shift the kinematics of the lever mechanism. It may for example happen that the toggle lever is strengthened and the action point is softened, if the brake lever is adjusted particularly close to the handlebar.

Furthermore, the systems may be rather delicate in respect of contamination, so as to increase wear or impair the function. This aspect is particularly significant with mountain bikes. Moreover, it should be ensured that the lever width does not unintentionally shift in operation.

In view of this, it is the object of the present invention to provide an improved hydraulic brake arrangement, which eliminates the drawbacks discussed above as far as possible, respectively fulfills the preferred requirements as far as possible.

### SUMMARY

The hydraulic brake arrangement according to the invention is provided for an at least partially muscle-powered bicycle. The brake arrangement comprises at least one master unit provided for fluid connection with a slave unit. The brake arrangement may comprise at least one slave unit and, in particular, a disk brake. The master unit comprises a pivotable brake lever (and a lever accommodation) and a cylinder housing, and a piston unit displaceably received in the cylinder housing. The brake lever acts on the pivotable cam body of an actuating mechanism, which serves to actuate the piston unit. To this end, the brake lever rests, with a pressure section, on a pressure area of the cam body. The brake lever and the cam body are jointly pivotable around the principal pivot axis (by pulling the brake lever). The brake lever is pivotable around the setting pivot axis relative to the cam body. A lever width adjusting system adjusts how far the brake lever pivots around the setting pivot axis relative to the cam body (and relative to the longitudinal axis of the handlebar to which the master unit can be mounted as intended), when the brake lever rests on the pressure area of the cam body. In particular, does the lever width adjusting system allow to adjust the distance and/or the pivoting angle of the brake lever relative to the handlebar to which the master unit is mounted as intended. Then the lever width adjusting system comprises a barrel nut which is supported in the brake lever to be non-rotatable (antitwist) and linearly displaceable (in the axial direction). The lever width adjusting system comprises a spindle unit rotatably supported in the brake lever and fixed in the axial direction. The barrel nut and the spindle unit are in engagement with one another so that the barrel nut is linearly displaceable respectively displaced by rotating the spindle unit. The barrel nut provides the pressure section on its barrel bottom.

The brake arrangement according to the invention offers many advantages. A considerable advantage is provided by the lever width adjusting system with its components interacting according to the invention, which can fulfill the requirements for setting the lever width discussed above, particularly reliably and at the same time structurally simple. Setting the lever width is performed without undesired influence on the kinematics for operating the piston unit. Also of particular advantage is the barrel nut which is linearly guided in the brake lever. It enables easy-glide and convenient adjustment, and offers reliable protection from dirt penetrating into the mechanism.

In an advantageous and preferred configuration, the principal pivot axis and the setting pivot axis are identical. In other words, the principal pivot axis and the setting pivot axis are one and the same pivot axis. In particular, are the brake lever and the cam body pivotally supported (on a lever accommodation) around the principal pivot axis. Thus, a very compact and easy implementation of the invention combined with a reduced quantity of components is provided. The principal pivot axis and the setting pivot axis are, in particular, coaxial.

In another advantageous and preferred configuration, the principal pivot axis is closer to the distal end of the brake lever than is the setting pivot axis. Then, in particular, the principal pivot axis and the setting pivot axis are configured separately and, in particular, spaced apart. This offers particularly ergonomic and at the same time very compact lever kinematics respectively lever width adjustment. Concurrently, this allows particularly fine-positioned angle adjustments in setting the lever width. Preferably, the cam body is supported on the lever accommodation, so that it can pivot around the principal pivot axis. The brake lever is preferably supported on the cam body, so that it can pivot (relative to the cam body) around the setting pivot axis. When the brake lever is pulled for braking, it pivots around the principal pivot axis, in particular, jointly with the cam body. Then, the brake lever is, in particular, supported on the pressure area of the cam body. The brake lever can, in particular, pivot around the principal pivot axis only jointly with the cam body.

The principal pivot axis and the setting pivot axis (and optionally a connecting rod pivot axis) extend, in particular, parallel to one another. The principal pivot axis and the setting pivot axis (and optionally a connecting rod pivot axis) extend, in particular, transverse to the longitudinal axis of the brake lever. The principal pivot axis is, in particular, closer than the setting pivot axis, to the end of the handlebar to which the master unit is fastened. The principal pivot axis is, in particular, closer than the setting pivot axis to the longitudinal axis of the handlebar and/or to the handlebar to which the master unit is mounted as intended. The brake arrangement may comprise at least one handlebar to which the master unit can be mounted as intended.

The principal pivot axis is, in particular, closer than the setting pivot axis to the pressure section and/or to the barrel nut and/or to the spindle unit. The principal pivot axis is, in particular, closer than the setting pivot axis, to the connecting rod pivot axis extending through the cam body. The connecting rod pivot axis, in particular, extends closer to the longitudinal axis of the handlebar, than the setting pivot axis and the principal pivot axis. The setting pivot axis is, in particular, farther away from the longitudinal axis of the handlebar than are the connecting rod pivot axis and the principal pivot axis.

The setting pivot axis is, in particular, closer to the proximal end of the handlebar than the principal pivot axis. In particular, is the setting pivot axis closer to the cylinder housing and/or to the piston unit than the principal pivot axis. The setting pivot axis is, in particular, closer than the principal pivot axis to the end of the cylinder housing to which the line device for connection with the slave unit can be joined. In particular, is the setting pivot axis farther remote than the principal pivot axis, from the longitudinal axis of the handlebar and/or from the handlebar, to which the master unit is mounted as intended.

The lever width adjusting system preferably comprises at least one rotary knob for rotating the spindle unit. Preferably, the spindle unit is non-rotatably connected with the rotary knob. The spindle unit is, in particular, plugged into a through hole of the rotary knob. The non-rotatable connection is, in particular, provided by form fit between the spindle unit and the rotary knob. For the form fit, the spindle unit and the rotary knob each comprise, in particular, at least one non-round section (for example toothing or the like). The non-round section of the rotary knob is, in particular, configured on the rotary knob wall surrounding the through hole.

Preferably, the rotary knob comprises a toothing on its radially outside surface. The toothing serves, in particular, to enhance rotating the rotary knob with fingers. The toothing may for example be configured as knurling or corrugated contour or the like.

It is possible and advantageous for the spindle unit to be accommodated on the brake lever secure, and preferably secure against loss, by means of the rotary knob. The spindle unit is fixed to the brake lever by means of the rotary knob, in particular, in respect of its axial movability. The barrel nut is, in particular, secured to the brake lever by means of the spindle unit.

The spindle unit extends, in particular, through a through hole in the brake lever. The brake lever, in particular, has a through hole through which the spindle unit extends. The through hole, in particular, extends from a side facing the barrel nut to a side of the brake lever facing the rotary knob.

In an advantageous configuration, the spindle unit comprises a flange section. The flange section is disposed on the spindle unit on a side of the through hole facing the barrel nut. The flange section protrudes, in particular, beyond the opening cross-section of the through hole (in the radial direction). In other words, the flange section does not fit through the through hole. Thus, the spindle unit is, in particular, fixed in one direction in its axial movability. The flange section is, in particular, configured firm and preferably integral with the spindle unit. The flange section, in particular, rests against the brake lever. The flange section, in particular, glides across the brake lever while the spindle unit rotates.

Preferably, the rotary knob is disposed on a side of the through hole facing away from the barrel nut. The rotary knob protrudes, in particular, beyond the opening cross-section of the through hole (in the radial direction). In other words, the rotary knob does not fit through the through hole. The rotary knob, in particular, rests on the brake lever directly or indirectly (for example by means of a sealing member) when the rotary knob is rotated. The brake lever is, in particular, accommodated in a form fit between the flange section and the rotary knob. The spindle unit is, in particular, fixed in its axial movability relative to the brake lever in both directions, by the flange section and the rotary knob.

In a preferred and advantageous configuration, the rotary knob is detachably fastened to the spindle unit. The spindle unit can, in particular, be inserted through the through hole without the rotary knob. A section of the spindle unit extending from the flange section to the end facing the rotating body, in particular, fits through the through hole. This is, in particular, the section which is in form-fit engagement with the rotary knob.

It is preferred and advantageous for the rotary knob to be fastened to the spindle unit by at least one (central) retaining screw extending in the axial direction. This enables uncomplicated mounting, and respectively easy servicing even for inexperienced users. The retaining screw, in particular, extends into the spindle unit through a through hole in the rotary knob. The spindle unit is, in particular, disposed between the rotary knob and the through hole. The retaining screw is, in particular, screwed into the internal thread of the spindle unit. Preferably, the retaining screw head seals the through hole in the rotary knob alone or in combination with a sealant.

The sealing element has, in particular, a (cylindrical) depression in its front face. The rotary knob and the retaining screw together, in particular, form a substantially flush front face when the retaining screw is accommodated respectively screwed in the depression. The front face is, in particular, curved convex (lenticular). Other front face geometries are likewise possible.

It is particularly preferred for the barrel nut to show elevations (on its radially outside surface) extending in the axial direction. Preferably, the brake lever has grooves corresponding with the elevations. Preferably, the barrel nut is linearly guided in the grooves by means of its elevations and is, in particular, torsion resistant. This allows uncomplicated manufacture of the barrel nut, also providing for easy gliding. The elevations in combination with the sealing element, in particular, serve as a limit stop when unscrewing the barrel nut. It is possible for the spindle unit to comprise a support collar which serves as a limit stop in screwing the barrel nut in.

In particular, multiple elevations are distributed over the barrel nut circumference. The brake lever, in particular, comprises a recess for accommodating the barrel nut. The grooves are, in particular, distributed along the circumference of the accommodating recess. The grooves are, in particular, incorporated in the brake lever (by material abrasion). The grooves, in particular, extend in the axial direction respectively in the longitudinal direction of the through hole.

The spindle unit preferably does not protrude, with its end facing the barrel nut, beyond the outer periphery of the brake lever. Also, the spindle unit preferably does not protrude with its end facing the rotary knob, beyond the outer periphery of the brake lever. This allows an integration in the brake lever which is particularly compact and provides protection from mechanical damaging and contamination.

The maximum length of the spindle unit, in particular, equals the thickness of the brake lever in the longitudinal direction of the spindle unit (in the position of the spindle unit). The end of the spindle unit facing the rotary knob, which protrudes from the through hole of the brake lever, is, in particular, completely covered by the rotary knob and/or the retaining screw. The end facing the barrel nut is, in particular, at least partially covered by the barrel nut.

In an advantageous specific embodiment, the rotary knob is (at least partially) recessed in the brake lever. In particular, does the rotary knob protrude beyond the outer periphery of the brake lever (only) in two opposite longitudinal faces of the brake lever. The rotary knob diameter is, in particular, larger than the brake lever width (in the position of the rotary knob). The brake lever, in particular, has a receiving groove (extending transverse to its longitudinal axis), in which the rotary knob is recessed. In particular, is the receiving groove configured open in at least one longitudinal face, and preferably in both opposite longitudinal faces.

Preferably, the barrel nut is (at least partially) recessed in the brake lever. The barrel nut, in particular, protrudes beyond the brake lever only on the side of the brake lever facing the cam body. In particular, is the barrel nut diameter smaller than the brake lever width.

The barrel nut is, in particular, recessed in an accommodating recess of the brake lever. The grooves and/or the sealing element described below are, in particular, disposed in the accommodating recess. The barrel nut and the spindle unit are, in particular, screw-connected to one another in the accommodating recess. The spindle unit, in particular, does not protrude beyond the accommodating recess. The accommodating recess and the through hole are in particular disposed coaxially. The diameter of the accommodating recess is, in particular, larger than the through hole.

In a preferred specific embodiment, the lever width adjusting system comprises at least one click-in mechanism for generating at least one click provided for haptic and/or acoustic perception when rotating the rotary knob. Preferably, the click-in mechanism comprises click-in depressions and at least one spring-biased click-in member for engagement in the click-in depressions. The click-in member is, in particular, a ball or the like. The click-in member may be configured separately from the biasing spring. The click-in member may be integrally connected with the biasing spring. Then, the click-in member is configured for example as a (distal) section of the biasing spring.

Preferably, the click-in mechanism comprises at least one biasing spring integrally connected with the brake lever for biasing the click-in member. In other words, the biasing spring is part of the material structure of the brake lever. To this end, part of the brake lever is, in particular, configured as a flexible respectively elastic section. For example, part of the brake lever is configured as a leaf spring or another suitable spring type. Additionally or alternately, the click-in member may be integrally connected with the brake lever.

The brake lever is preferably manufactured by means of an additive production process and for example by 3D printing or the like. The brake lever is, in particular, configured as one piece. It is also possible for the biasing spring to be integrally connected with another component of the brake arrangement. In particular, at least the biasing spring is manufactured by means of an additive production process and for example by 3D printing or the like. The applicant reserves the right to claim a brake arrangement having a click-in mechanism for a lever width adjusting system, wherein the click-in mechanism comprises a biasing spring integrally connected with the brake lever and/or another component of the brake arrangement.

The click-in member is, in particular, disposed on the spindle unit and preferably in the flange section. Preferably, the click-in depressions are disposed in the brake lever and, in particular, incorporated in the brake lever (by material abrasion). A reverse configuration is also possible, so that the click-in member and/or the biasing spring is/are disposed on the brake lever and the click-in depressions, in the spindle unit. Then, the spindle unit may have e.g. a star-shaped outer contour to provide the click-in depressions.

The spindle unit, preferably the flange section, in particular, comprises a radially extending takeup space. At least one biasing spring is, in particular, disposed in the takeup space. The click-in member can, in particular, be urged radially outwardly into the click-in depressions by means of the biasing spring. The takeup space is, in particular, manufactured by drilling or a similar process. The takeup space may be in the brake lever. Then the click-in member can, in particular, be urged radially outwardly into the click-in depressions of the spindle unit.

In an advantageous configuration, the click-in depressions are provided by the grooves for linearly guiding the barrel nut. The click-in depressions may be configured separately from the grooves. The click-in depressions are, in particular, disposed in, and distributed over the circumference of, the accommodating recess.

It is preferred and advantageous for at least one sealing element to be disposed between the barrel nut and the brake lever. The sealing element is preferably fixed to the brake lever. In particular, is the sealing element disposed in a groove of the brake lever annularly surrounding the barrel nut. Alternately, the sealing element may be fixed to the barrel nut. Then, the barrel nut, in particular, comprises a peripheral groove. The sealing element is, in particular, configured as a sealing ring and for example an O-ring or the like. Thus, the accommodating recess and the linear guide of the barrel nut, and the threaded joint between the spindle unit and the barrel nut, are reliably protected from dirt and water.

It is likewise preferred and advantageous for at least one sealing member to be disposed between the front face of the rotary knob facing the brake lever, and the brake lever. This will reliably prevent dirt or water from penetrating into the mechanism from this side. The sealing member, in particular, rests against the brake lever in the region of the accommodating recess. Preferably, the sealing member surrounds the spindle unit annularly, and spaced apart from the spindle unit. In particular, is the sealing member fixed to the rotary knob and preferably fastened in an annular groove of the rotary knob. The sealing member may also be fixed to the brake lever. Then, the brake lever comprises, in particular, an annular groove, in which the sealing member is fastened. The sealing member is, in particular, a sealing ring. The sealing member is, in particular, configured as a molded seal and for example a lip seal with sealing lips disposed in a v-shape or an x-shape.

In all the configurations it is particularly preferred for the barrel nut and, in particular, the pressure section to only rest loosely on the pressure area of the cam body. Thus, setting the lever width with the lever width adjusting system presented herein, does not result in an undesired shift of the kinematics. In particular, are the pressure section and the pressure area not fastened to one another. External of the (shared) principal pivot axis and/or the setting pivot axis, the cam body and the brake lever are preferably not interconnected and, in particular, not screw-connected or otherwise joined.

It is possible and advantageous for the cam body and the brake lever to be urged to one another by means of biasing respectively by the spring force of a biasing device. The cam body and the brake lever can, in particular, be pivoted independently of one another in at least one direction over at least one pivoting angle range. The cam body and the brake lever are, in particular, not non-rotatably interconnected (over the entire pivoting angle range).

It is possible for the brake lever and/or the cam body to be biased by means of a biasing device so that the pressure section and the pressure area are urged against one another (by spring force). The biasing device, in particular, comprises at least one spring. Preferably, the at least one spring is configured as a coil spring. Other spring types are likewise possible. The at least one spring is, in particular, disposed at the proximal end of the brake lever. The spring is, in particular, closer to the setting pivot axis than to the principal pivot axis. The setting pivot axis lies, in particular, between the spring and the principal pivot axis. The direction of force of the spring extends, in particular, transverse to the setting pivot axis and to the principal pivot axis and/or transverse to the longitudinal axis of the brake lever. Preferably, at least two springs are provided. The at least two springs are, in particular, disposed adjacent in parallel. The springs are, in particular, configured identically. Both the springs are, in particular, configured as described above.

It is advantageous and preferred for the pressure section to be curved. In particular, is the barrel bottom configured curved at least in the pressure section. In particular, is the cam body configured curved in the pressure area, corresponding to the pressure section. The pressure section and the pressure area are, in particular, matched to one another and preferably curved, so that the pressure section does not cant to the cam body, given the lever width settings provided as intended.

It is possible and advantageous for the (entire) lever width adjusting system to be fastened (only) to the brake lever. In particular, does the lever width adjusting system form an assembly unit together with the brake lever and preferably with the cam body and, in particular, with the biasing device as well. Thus, the assembly unit can be handled as one component and can preferably be detached from the lever accommodation of the master unit and reattached to the lever accommodation, as one component. Thus, for example even inexperienced users can retrofit a brake lever with a lever width adjusting system, for a conventional brake lever. It is possible for the brake lever and the cam body to be fastened to one another by means of a pin or the like in the region of the setting pivot axis, to provide the assembly unit.

The applicant reserves the right to claim a bicycle with a hydraulic brake arrangement, as it is described herein. Such a bicycle likewise fulfills particularly advantageously the object indicated above.

In particular, is the lever width adjusting system suitable and configured to set the pivoting angle respectively distance of the brake lever from the handlebar, to which the master unit is mounted as intended. In particular, is the lever width adjusting system suitable and configured to adjust the lever width without shifting the kinematics of the brake lever and the actuating mechanism (in particular, the toggle lever principle). Setting the lever width by means of the lever width adjusting system, in particular, only pivots the brake lever relative to the cam body, around the (shared) principal pivot axis and/or the setting pivot axis.

The brake lever is, in particular, operatively coupled with the piston unit by means of the actuating mechanism. The brake lever acts, in particular, immediately on the cam body. In particular, does the cam body act on the piston unit by means of further components of the actuating mechanism. The cam body, in particular, comprises a cam which protrudes radially outwardly lever-like, starting from the pivot axis. The pressure area is, in particular, configured on a side of the cam facing the barrel nut.

The (shared) principal pivot axis and/or the setting pivot axis of the brake lever and the cam body, in particular, extend/s transverse and preferably orthogonal to the longitudinal axis of the spindle unit. The barrel nut is, in particular, linearly displaceable, transverse and preferably orthogonal, to the (shared) pivot axis and/or the setting pivot axis. In the region of the (shared) principal pivot axis and/or the setting pivot axis, the brake lever and the cam body can be pivotally fastened to one another. For example, in this region the cam body is secured in the brake lever by a pin or the like.

The longitudinal axis of the lever width adjusting system, in particular, the longitudinal axis of the spindle unit and/or of the barrel nut and/or of the through hole and/or of the rotary knob, in particular, extend/s transverse to the longitudinal axis of the brake lever. The spindle nut and/or the rotary knob and/or the barrel nut and/or the brake lever are, in particular, configured integrally. The flange section and the support collar are, in particular, configured integrally with the remainder of the spindle unit. In particular, is the lever accommodation configured integrally with the cylinder housing. The cylinder housing and the lever accommodation and at least a part of the handlebar mount are, in particular, integral components of the base body of the master unit.

The barrel nut and the spindle unit are, in particular, interconnected in a form-fit and preferably by means of a threaded joint. The spindle unit and the barrel nut, in particular, each have a thread by means of which they are in engagement with one another. The barrel nut, in particular, comprises an internal thread corresponding with the external thread of the spindle unit. The spindle unit extends, in particular, into the barrel nut with one end. This end is, in particular, entirely covered by the barrel bottom. In particular, is the barrel nut completely closed at the barrel bottom.

In particular, the following components of the lever width adjusting system are disposed coaxially to one another, if provided in the configuration concerned: spindle unit, barrel nut, rotary knob, retaining screw, through hole, sealing element, sealing member, accommodating recess.

The piston unit is, in particular, operatively coupled with the brake lever through the actuating mechanism, such that the piston unit is displaced in the cylinder space as the master unit is actuated. The master unit is, in particular, actuated at the brake lever. The actuating mechanism comprises, in particular, at least one connecting rod device (with a connecting rod and a connecting rod small end). In particular, is the connecting rod small end firmly connected with the connecting rod. In particular, is the connecting rod device configured as one piece. The connecting rod device (with its connecting rod) is, in particular, pivotally linked to the cam body around the connecting rod pivot axis. In particular, the connecting rod device and the cam body are pivotable relative to one another. The connecting rod pivot axis, in particular, extends through the cam body. The connecting rod device, in particular, provides a pressing connection (and optionally also a pulling connection) between the cam body and the piston unit.

In the scope of the present invention, the principal pivot axis and the setting pivot axis are, in particular, understood to mean imaginary axes. Pivoting around the principal pivot axis and the setting pivot axis is, in particular, provided by supporting components known per se (pins, bolts, bushings and/or bearings etc.). The brake lever and the cam body are, in particular, fastened to, and preferably pivotally supported on, a lever accommodation. The cylinder housing is, in particular, integrally connected with the lever accommodation. The cylinder housing and the lever accommodation are, in particular, incorporated in a (/an integral) base body.

Further advantages and features of the present invention can be taken from the exemplary embodiments which will be described below with reference to the enclosed figures.

### BRIEF DESCRIPTION OF THE DRAWINGS

The figures show in:

FIG. 1 a schematic illustration of a mountain bike with a brake arrangement according to the application;

FIG. 2 a schematic illustration of a racing bicycle with a brake arrangement according to the application;

FIG. 3 a schematic illustration of a brake arrangement according to the application on the handlebar of a bicycle in a top view;

FIG. 4 the washer of the FIG. 3 in a perspective detail view;

FIG. 5 the brake arrangement in a detail section view;

FIG. 6 another detail section view of the brake arrangement;

FIG. 7 yet another detail section view of the brake arrangement;

FIG. 8 a schematic illustration of another brake arrangement according to the application on the handlebar of a bicycle in a top view;

FIG. 9 a schematic illustration of another brake arrangement;

FIG. 10 a schematic detail illustration of another brake arrangement; and

FIG. 11 a detail section view of the brake arrangement of FIG. 10.

### DETAILED DESCRIPTION

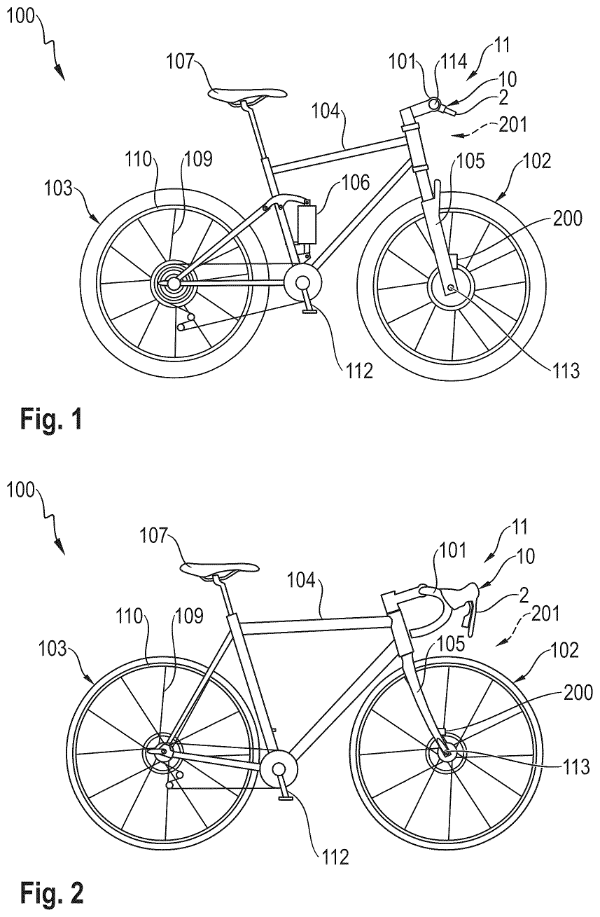

The FIGS. 1 and 2 illustrate bicycles 100 configured as a mountain bike respectively racing bicycle, each equipped with a hydraulic brake arrangement 1 according to the application. The bicycles 100 are each provided with a front wheel 102 and a rear wheel 103, provided to be braked separately by means of separate hydraulic circuits 11. To this end, the hydraulic circuits 11 each comprise a master unit 10 and a slave unit 200.

A bicycle 100 comprises a frame 104, a handlebar 101 with grips 114, a saddle 107, a fork or suspension fork 105 and in the case of the mountain bike, a rear wheel damper 106 may be provided. A pedal crank 112 with pedals serves for driving. Optionally, the pedal crank 112 and/or the wheels 102, 103 may be provided with an electric auxiliary drive. Each of the wheels 102, 103 comprises a rim 110, which is connected with a hub by means of spokes 109. The hubs of the wheels 102, 103 may each be attached to the frame 104 or the fork 105 by means of a clamping system 113 (for example a through axle or a quick release).

The frame 104 and the fork 105 each have a slave unit 200 fastened thereto, presently configured as hydraulic disk brakes. The slave unit 200 is connected with the associated master unit 10 by means of a line device 201, not visible, such that a closed hydraulic circuit 11 results. The master units 10 of a bicycle 100 are mounted to opposite ends of the handlebar 101, each showing a brake lever 2 provided for finger actuation. In the racing bicycle 100, the master unit 10 is configured as a shifting-braking combination.

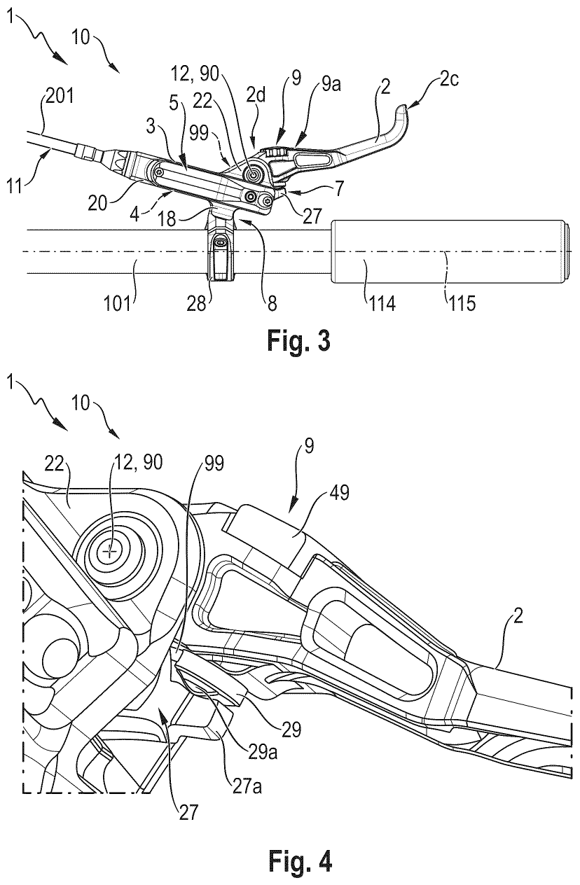

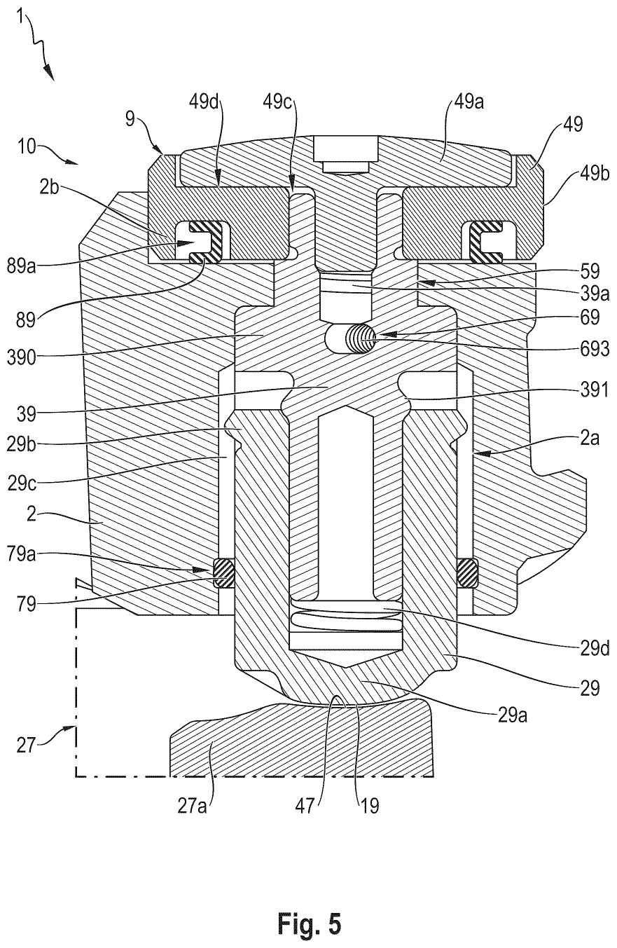

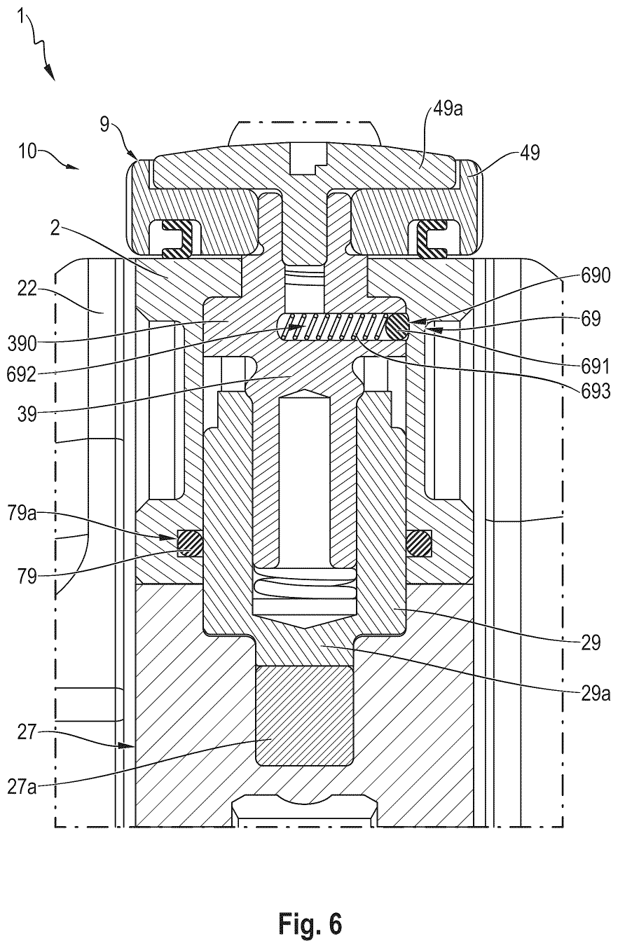

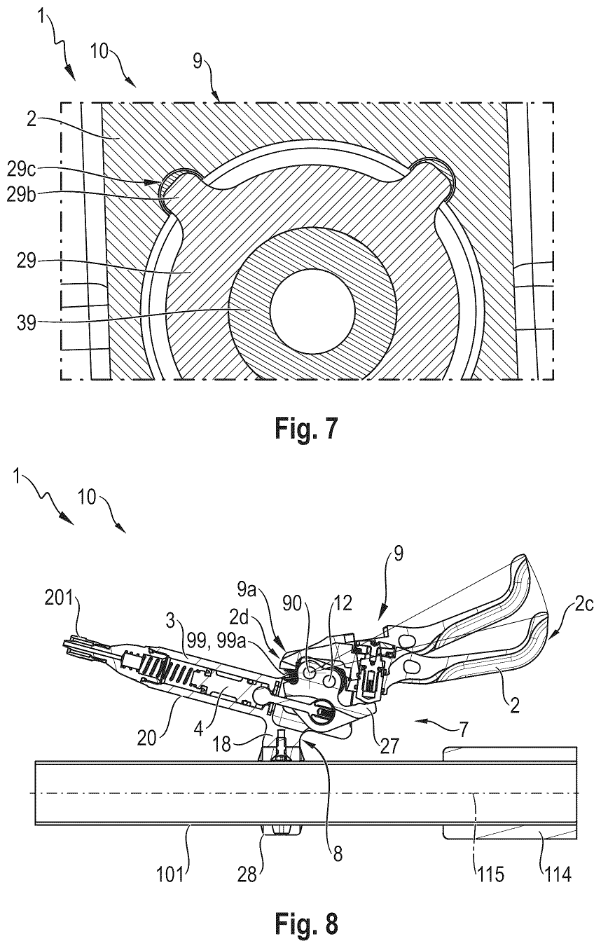

The brake arrangement 1 according to the application will now be described in detail with reference to the various views of the FIGS. 3 to 7.

The master unit 10 is fastened to the handlebar 101 of a bicycle 100, presently by means of a handlebar link 8, in a mounting position as intended. The handlebar link encloses the handlebar 101 with two linking sections 18, 28. The master unit 10 comprises a cylinder housing 3 and a piston unit 4 (not visible, in the interior) displaceably accommodated in the cylinder space 3. The cylinder housing 3 comprises a connection port for coupling the line device 201.

A brake lever 2 is supported on a lever accommodation 22 so that said lever can pivot around the principal pivot axis 12. The brake lever 2 is coupled to the piston unit 4 by means of an actuating mechanism 7, in the region of its proximal end 2d. The actuating mechanism 7 comprises a cam body 27 with a cam 27a. The cam body 27 is supported on the lever accommodation 22, such that it can likewise pivot around the principal pivot axis 12. Thus, the brake lever 2 and the cam body 27 share the same principal pivot axis 12 and basically rest loosely on top of one another. The distal end 2c of the brake lever 2 protrudes in the direction of the end of the handlebar 101.

Pulling the brake lever 2 causes displacement of the piston unit 4 in the cylinder space 3, so as to build up the brake pressure in the hydraulic circuit 11. The cylinder housing 3 and the lever accommodation 22, and also the linking section 18, are integral components of an integral base body 20. For storing hydraulic fluid, an equalizing reservoir device 5 is provided. The hydraulic fluid provided is e.g. a biologically decomposable oil. Alternately, mineral oil or brake fluid (DOT) may be provided.

For setting the desired lever width, a lever width adjusting system 9 is incorporated in the brake lever 2. It allows presetting how far the brake lever 2 pivots relative to the cam body 27 around the setting pivot axis 90 (presently identical with the principal pivot axis 12), when it rests on the pressure area 47 of the cam 27a. Depending on the position of the brake lever 2 relative to the cam body 27, the desired distance results between the brake lever 2 and the handlebar 101 respectively grip 114. To retain the brake lever 2 in the desired position, the brake lever 2 and the cam body 27 are urged to one another by means of a biasing device 99. To this end, the biasing device 99 comprises for example two strong, parallel coil springs (compression springs).

The lever width adjusting system comprises a barrel nut 29 non-rotatably supported in the brake lever 2 and linearly displaceable, and a spindle unit 39 rotatably supported in the brake lever 2 and fixed in the axial direction. The spindle unit 39 has an external thread in engagement with the internal thread 29d of the barrel nut 29.

At its top end, the spindle unit 39 is non-rotatably connected with a rotary knob 49. To this end, a top section of the spindle unit 39 is accommodated in a form-fit in the through hole 49c of the rotary knob 49. The spindle unit 39 extends from the rotary knob 49 through a through hole 59, and further into an accommodating recess 2a of the brake lever 2, where it is connected with the barrel nut 29. The rotary knob 49 and the spindle unit 39 are fixed to the brake lever 2 by means of a retaining screw 49a, which is screwed into the internal thread 39a of the spindle unit 39.

On a side of the through hole 59 facing away from the rotary knob 49, the spindle unit 39 rests against the brake lever 2 with a flange section 390. Thus, the spindle unit 39 is fixed to the brake lever 2 in both axial directions, through the flange section 390 and the rotary knob 49.

For linear guidance and anti-twist protection, the outside surface of the barrel nut 29 is provided with elevations 29b. In the accommodating recess 2a of the brake lever 2, grooves 29c are incorporated, in which the elevations 29b glide in the axial direction when the barrel nut 29 is adjusted. The grooves 29c are for example configured as axial bores, which are drilled into the brake lever 2 from the side of the cam body 27.

Rotating the spindle unit 39 by the rotary knob 49 causes the barrel nut 29 to move out of, and into, the brake lever 2. Then, the barrel bottom 29a is urged against the pressure area 47 of the cam body 27 with its pressure section 19. The pressure section 19 is curved and matches the pressure area 47, so that the barrel nut 29 always assumes the proper angle and cannot jam or tilt. For simple and easy rotation of the rotary knob 49 with fingers, it has a circumferential toothing 49b with rounded edges.

The elevations 29b in combination with a sealing element 79 also serve as a limit stop in unscrewing the barrel nut 29. A support collar 391 of the spindle unit 39 serves as a limit for moving the barrel nut 29 in.

To provide for a protected and compact, and optically appealing, incorporation of the lever width adjusting system in the brake lever 2, only the barrel nut 29 moves out of the brake lever 2 when setting the lever width. The spindle unit 39 never protrudes beyond the outer periphery of the brake lever 2 on any side. Moreover, the rotary knob 49 is recessed in the receiving groove 2b of the brake lever 2. The receiving groove 2b is open on its longitudinal faces, so as to provide for accessibility of the rotary knob 49 for rotating with fingers. The diameter of the rotary knob 49 is selected such that it protrudes from the receiving groove 2b on the longitudinal faces of the brake lever 2, to allow for rotation with two fingers requiring little operating force. Furthermore, the retaining screw 49a is recessed in a cylindrical depression 49 of the rotary knob 49, so as to provide a flush front face.

Since the linear guide also offers anti-twist protection, the remaining components can be round respectively cylindrical. This enables simple manufacture, combined with a structurally uncomplicated sealing from environmental influences. To this end, for example a sealing element 79 configured as an O-ring is provided, which is fastened in the accommodating recess 2a in a circumferential groove 79a and bears against the barrel nut 29 so as to seal it. Further sealing is provided between the brake lever 2 and the rotary knob 49. To this end, a sealing member 89 is provided which is fastened in an annular groove 89a of the rotary knob 49. The sealing member shown is a molded seal having e.g. a v-shaped or x-shaped cross section.

The lever width adjusting system 9 with its components is only fastened to the brake lever 2, so that it can be handled as one assembly unit 9a together with the brake lever 2. Additionally, a safety device and for example a pin may be provided, which secures the cam body 27 to the shared principal pivot axis 12 in the brake lever 2. The bias of a biasing device 99 thus allows preassembling the brake lever 2 together with the cam body 27 as one unit, without detaching the cam body 27 from the brake lever 2.

For haptic and acoustic feedback when rotating the rotary knob 49, a click-in mechanism 69 is provided. To this end, a receiving space 692 is configured in the flange section 390, in which a biasing spring 693 and a click-in member 691 are disposed. The click-in member 691 is urged radially outwardly by the biasing spring 693 into click-in depressions 690 of the brake lever 2. The click-in depressions 690 may be provided by the grooves 29c, or also by separate grooves.

FIG. 8 shows a variant of the brake arrangement 1 described with reference to FIG. 3. The setting pivot axis 90 is configured separately from the principal pivot axis 12. The principal pivot axis 12 is closer than the setting pivot axis 90 to the distal end 2c of the brake lever 2.

The cam body 27 is supported on the lever accommodation 22, such that it can pivot around the principal pivot axis 12. The brake lever 2 is supported on the cam body 27, such that it can pivot around the setting pivot axis 90 (relative to the cam body 27). When the brake lever 2 is pulled for braking, it pivots around the principal pivot axis 12, jointly with the cam body 27. The brake lever 2 is supported on the pressure area 47 of the cam body 27.

For illustrating the pivoting motion of the brake lever 2 around the setting pivot axis 90, the brake lever 2 is also shown in a position with an enlarged lever width. As is clearly shown, the brake lever 90 pivots outwardly around the setting pivot axis 90, so that finally, its distal end 2c is positioned farther away from the handlebar 101 respectively the grip 114.

Also clearly shown are the coil springs 99a of the biasing device 99 configured as compression springs. The coil springs 99a are adjacent in parallel and disposed closer to the setting pivot axis 90 than to the principal pivot axis 12. The direction of force of the coil springs 99a extends transverse to the setting pivot axis 90 and the principal pivot axis 12, and transverse to the longitudinal axis 115 of the brake lever 2.

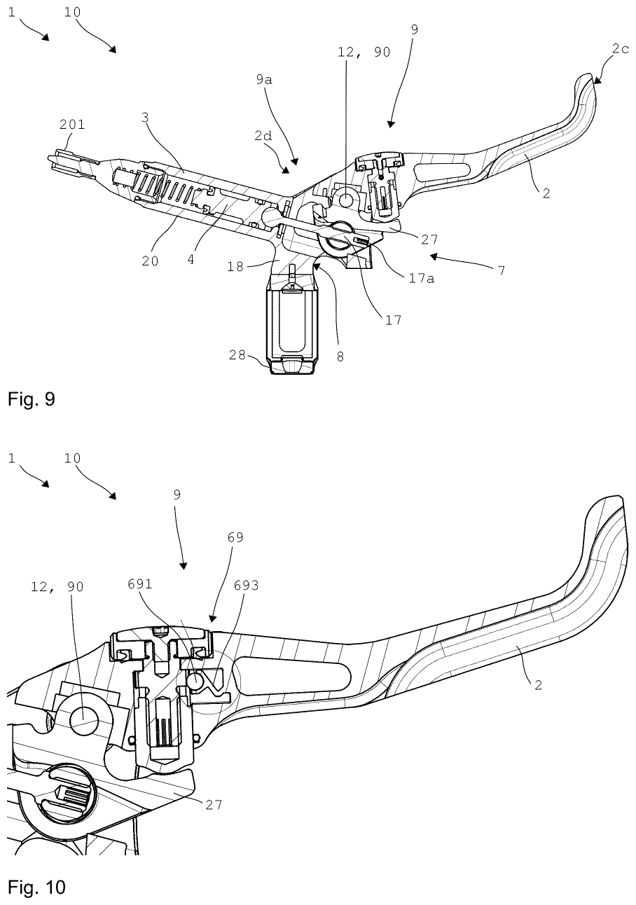

The FIG. 9 shows a variant of the brake arrangement 1 described with reference to FIG. 8, wherein, in addition to the lever width, the brake lever kinematics can be adjusted as well. To this end, a connecting rod 17 of the actuating mechanism 7 is screw-connected with the cam body 27. Rotating the connecting rod 17 causes movement of the cam body 27 relative to the connecting rod, to thus change the lever kinematics. The connecting rod 17 is provided with a tool socket 17a for rotating. For example, the lever kinematics is first adapted to the requirements at the time (wherein the lever width is adjusted as well). Thereafter, the lever width is adjusted (as described above). Then, the lever width can also be adjusted in this variant by means of the lever width adjusting system 9, independently of the lever kinematics.

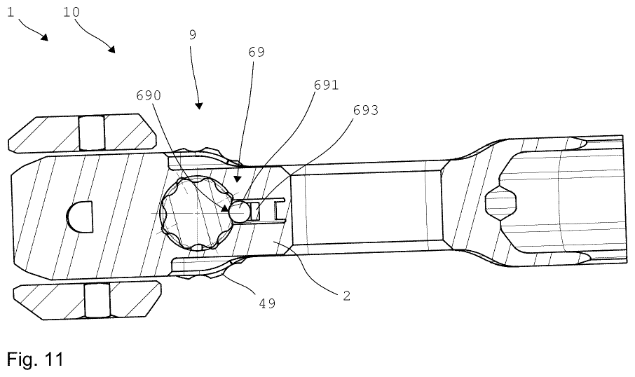

FIGS. 10 and 11 show a brake arrangement 1, whose click-in mechanism 69 comprises a biasing spring 693 integrally connected with the brake lever 2. To this end, the brake lever 2 is manufactured by means of an additive production process and for example by 3D printing. The material provided is e.g. a titanium material or another suitable lightweight material. To protect the biasing spring 693 from wear, it does not directly interact with the click-in depressions 690. The biasing spring 693 presses on a click-in member 691, here configured as a ball. The ball is e.g. of steel or another material of comparable hardness. The ball is then urged into click-in depressions 690 by the biasing spring 693. The click-in depressions 690 are provided by a star-shaped outer contour of the spindle unit.

While a particular embodiment of the present hydraulic brake arrangement for an at least partially muscle-powered bicycle have been described herein, it will be appreciated by those skilled in the art that changes and modifications may be made thereto without departing from the invention in its broader aspects and as set forth in the following claims.

### LIST OF REFERENCE NUMERALS

1 brake arrangement
2 brake lever
2a accommodating recess
2b receiving groove
2c end
2d end
3 cylinder housing
4 piston unit
5 equalizing reservoir device
7 actuating mechanism
8 handlebar link
9 lever width adjusting system
9a assembly unit
10 master unit
11 hydraulic circuit
12 principal pivot axis
17 connecting rod device
17a tool socket
18 linking section
19 pressure section
20 base body
22 lever accommodation
27 cam body
27a cam
28 linking section
29 barrel nut
29a barrel bottom
29b elevation
29c groove
29d thread
39 spindle unit
39a thread
47 pressure area
49 rotary knob
49a retaining screw
49b toothing
49c through hole
49d depression
59 through hole
69 click-in mechanism
79 sealing element
79a groove
89 sealing member
89a annular groove
90 setting pivot axis
99 biasing device
99a coil spring
100 bicycle
101 handlebar
102 Wheel, front wheel
103 Wheel, rear wheel
104 frame
105 fork, suspension fork
106 rear wheel damper
107 saddle
109 spoke
110 rim
112 pedal crank
113 clamping system
114 grip
115 longitudinal axis
200 slave unit
201 line device
390 flange section
391 support collar
690 click-in depression
691 click-in member
692 takeup space
693 biasing spring

1. A hydraulic brake arrangement for an at least partially muscle-powered bicycle, comprising: at least one master unit provided for fluid connection with a slave unit, wherein the master unit comprises a pivotable brake lever and a cylinder housing; and a piston unit displaceably received in the cylinder housing; wherein the brake lever acts on the pivotable cam body of an actuating mechanism for actuating the piston unit; and to this end it rests on the pressure area of the cam body with the pressure section; wherein the brake lever and the cam body are jointly pivotable around the principal pivot axis by pulling the brake lever; and wherein the brake lever is pivotable relative to the cam body around the setting pivot axis; and wherein a lever width adjusting system presets how far the brake lever pivots relative to the cam body around the setting pivot axis, when it rests on the pressure area of the cam body;
the lever width adjusting system comprises a barrel nut non-rotatably supported and linearly displaceable in the brake lever; and a spindle unit rotatably supported in the brake lever and fixed in the axial direction; and the barrel nut and the spindle unit are in engagement with one another, so that the barrel nut is linearly displaceable by rotating the spindle unit, and that the barrel nut provides the pressure section on its barrel bottom.

2. The brake arrangement according to claim 1, wherein the principal pivot axis and the setting pivot axis are identical, or wherein the principal pivot axis is closer to the distal end of the brake lever than is the setting pivot axis.

3. The brake arrangement according to claim 1, wherein the spindle unit is non-rotatably connected with a rotary knob, so that the spindle unit can be rotated by rotating the rotary knob, and wherein the spindle unit is secured to the brake lever by means of the rotary knob.

4. The brake arrangement according to claim 1, wherein the spindle unit extends through a through hole in the brake lever, and wherein the spindle unit comprises a flange section on a side of the through hole facing the barrel nut, which protrudes beyond the opening cross-section of the through hole.

5. The brake arrangement according to claim 1, wherein the rotary knob is disposed on a side of the through hole facing away from the barrel nut and protrudes beyond the opening cross-section of the through hole, and wherein the rotary knob is detachably fastened to the spindle unit, so that the spindle unit can be inserted through the through hole without the rotary knob, and wherein the rotary knob is fastened to the spindle unit by at least one central retaining screw extending in the axial direction.

6. The brake arrangement according to claim 1, wherein the barrel nut comprises elevations extending in the axial direction, and wherein the brake lever comprises grooves corresponding with the elevations, so that the barrel nut is linearly guided in the grooves and is torsion resistant.

7. The brake arrangement according to claim 1, wherein the spindle unit, with its end facing the barrel nut, does not protrude beyond the outer periphery of the brake lever, and wherein the spindle unit preferably does again not protrude, with its end facing the rotary knob, beyond the outer periphery of the brake lever.

8. The brake arrangement according to claim 3, wherein the rotary knob is recessed in the brake lever and protrudes beyond the brake lever in two opposite longitudinal faces of the brake lever, and wherein the barrel nut is recessed in the brake lever and protrudes beyond the brake lever in particular only on the side of the brake lever facing the cam body.

9. The brake arrangement according to claim 1, comprising a click-in mechanism for generating at least one click provided for haptic and/or acoustic perception when rotating a rotary knob, wherein the click-in mechanism comprises click-in depressions and at least one spring-biased click-in member for engaging in the click-in depressions.

10. The brake arrangement according to claim 9, wherein the click-in mechanism comprises at least one biasing spring integrally connected with the brake lever for biasing the click-in member, and wherein the brake lever is preferably manufactured by means of an additive production process.

11. The brake arrangement according to claim 1, wherein at least one sealing body is disposed between the barrel nut and the brake lever.

12. The brake arrangement according to claim 3, wherein at least one sealing member is disposed between the front face of the rotary knob facing the brake lever, and the brake lever.

13. The brake arrangement according to claim 1, wherein the barrel nut rests only loosely on the pressure area of the cam body.

14. The brake arrangement according to claim 1, wherein the pressure section is configured curved, and wherein the cam body is curved in the pressure area corresponding to the pressure section, so that the pressure section does not cant to the cam body in any lever width setting provided.

15. The brake arrangement according to claim 1, wherein the lever width adjusting system is fastened to the brake lever and, together with the brake lever, forms an assembly unit which can be handled as one component, and can preferably be detached from, and reattached to, the lever accommodation of the master unit as one component.
